(19) United States
(12) Patent Application Publication
(10) Pub. No.: US 2025/0260337 A1
(43) Pub. Date: Aug. 14, 2025

(54) MODULAR MULTILEVEL FLYING CAPACITOR CONVERTER

(71) Applicant: Ohio State Innovation Foundation, Columbus, OH (US)

(72) Inventors: Pengyu Fu, Columbus, OH (US); Dihao Ma, Columbus, OH (US); Jin Wang, Columbus, OH (US); Ke Wang, Columbus, OH (US); Yizhou Cong, Columbus, OH (US)

(21) Appl. No.: 19/046,648

(22) Filed: Feb. 6, 2025

Related U.S. Application Data
(60) Provisional application No. 63/551,588, filed on Feb. 9, 2024.

(51) Int. Cl. H02M 7/483; H02M 7/5387

(52) U.S. Cl. CPC H02M 7/4837; H02M 7/4833; H02M 7/53876

(57) ABSTRACT

A modular multilevel flying capacitor (MMFC) converter that seamlessly integrates features of flying capacitor converter and conventional modular multilevel converters. The converter achieves higher voltage and power handling capabilities, along with substantial cost, weight, and size reductions for High Voltage DC (HVDC) systems as the MMC arms within the MMFC converter only sustain half of the full DC voltage. Therefore, the required number of expensive submodules is halved, and size and weight of the total capacitors can be significant reduced, irrespective of the submodule topologies, whether the submodules contain half-bridge or full-bridge switch poles or T-type converter submodule or full-bridge T-type converter submodule or any other submodule topologies. The switches for MMC submodules can be implemented with any type of fully controllable switches made of any types of semiconductor materials.

### CROSS-REFERENCE TO RELATED APPLICATION

This application claims priority to U.S. Provisional Patent Application No. 63/551,588, filed Feb. 9, 2024, entitled “Modular Multilevel Flying Capacitor Converter,” the disclosure of which is expressly incorporated herein in its entirety.

### BACKGROUND

The modular multilevel converter (MMC) is favored for voltage source converter (VSC)-based HVDC projects due to its modularity, scalability, and suitability for back-to-back connections. However, the power and voltage ratings are restricted by switching device ratings and the weight, size, and cost of capacitors in MMC submodules. The capacitors in the MMC not only contribute to additional submodule costs but also increase the expenses associated with the converter assembly.

### SUMMARY

To achieve higher voltage and power handling capabilities, along with substantial cost, weight, and size reductions for High Voltage DC (HVDC) systems, a modular multilevel flying capacitor (MMFC) converter is disclosed that seamlessly integrates features of flying capacitor converter and conventional modular multilevel converters. The MMC arms within the MMFC converter only sustain half of the full DC voltage. Therefore, the required number of expensive submodules is halved, and size and weight of the total capacitors can be significant reduced, irrespective of the submodule topologies, whether the submodules contain half-bridge or full-bridge switch poles or T-type converter submodule or full-bridge T-type converter submodule or any other submodule topologies. The switches for MMC submodules can be implemented with any type of fully controllable switches (IGBT, IGCT, MOSFET, HEMT, etc.), made of any types of semiconductor materials (Si, SiC, GaN, Ultrawide Bandgap Semiconductors, etc.).

The high-voltage switches S_{Ua} and S_{La} in the MMFC converter will sustain half of the full DC voltage, which can be implemented with any fully controllable switch that has half of the full DC voltage rating (such as single switch, series-connected switches, etc.). In the disclosed operation principle, the high-voltage switches operate at fundamental frequency, effectively reducing the switching stress and associated power loss. Subsequently, the total power loss of MMFC is significantly reduced.

The maximum voltage of the flying capacitor is half of the full DC voltage, which can be implemented by stacking the same type of capacitors for MMC submodules with reduced current rating. The additional benefit of adding the flying capacitor includes protecting the high-voltage switches by clamping the voltage. Since only one flying capacitor is added, the voltage regulation of the flying capacitor voltage can be easily achieved.

With the reduction of total submodules by half, the total capacitance of capacitors in the proposed MMFC converter—encompassing the capacitor-stack for the flying capacitor and the capacitors in the submodules—can be reduced to two-thirds of the conventional MMC. Also, due to the reduction of total submodules, the total installation power of switching devices and the associated total cost of installed power switches are significantly reduced.

Additional features, operation principles, control methods, advantages, and other aspects of the MMFC converter are described below with reference to the accompanying drawings.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 illustrates a single-phase circuit diagram of the conventional 3-level flying capacitor circuit.

FIG. 2 illustrates a three-phase circuit diagram of the conventional modular multilevel converter with 2N submodules in each MMC arm.

FIG. 3 illustrates a single-phase circuit diagram of the proposed MMFC circuit with series-connected IGBT devices as high-voltage switches and N submodules in each MMC arm, and it can be easily extended to multi-phase circuit by duplicating the circuit for each phase.

FIG. 4a illustrates a circuit diagram of an exemplary half-bridge submodule with Si IGBTs in accordance with the MMFC converter.

FIG. 4b illustrates a circuit diagram of an exemplary full-bridge submodule with Si IGBTs in accordance with the MMFC converter.

FIG. 4c illustrates a circuit diagram of an exemplary T-type converter submodule with Si IGBTs and SiC MOSFETs in accordance with the MMFC converter.

FIG. 4d illustrates a circuit diagram of an exemplary full-bridge T-type converter submodule with Si IGBTs and SiC MOSFETs in accordance with the MMFC converter.

FIG. 5 illustrates a diagram of the working principle of the MMFC converter, showing the output voltage synthesis principle and the voltage waveforms of the key components in a fundamental cycle.

FIG. 6 illustrates a detailed diagram of the MMC arm control in MMFC converter for synthesizing the output voltage and balancing the capacitor voltages.

FIG. 7 illustrates the exemplary waveforms of the control signals for the high-voltage switches, generated PWM voltages across the 3-level MMC upper arms in phase a and phase b, the output phase voltages, and the output line-line voltage in two fundamental cycles.

### DETAILED DESCRIPTION

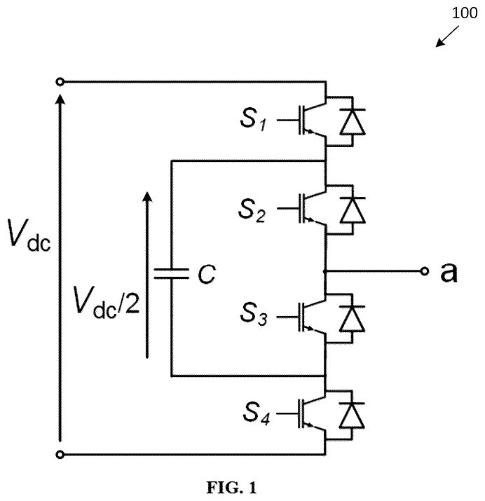

FIG. 1 illustrates a circuit diagram of a conventional three-level flying capacitor converter 100. The circuit includes four switching devices S₁, S₂, S₃, and S₄, each implemented with an IGBT and an anti-parallel diode. A flying capacitor C is connected between the midpoints of the upper and lower switch pairs, maintaining a voltage of approximately V_{dc}/2.

The flying capacitor converter 100 of FIG. 1 operates by switching the semiconductor devices in complementary pairs to generate three voltage levels at the output terminal ‘a’. Specifically, switches S₁ and S₄ operate as complementary pairs, as do S₂ and S₃. The flying capacitor C serves as an intermediate voltage level source and helps distribute the voltage stress across the switching devices.

This conventional topology, while effective for medium-voltage applications, faces limitations in high-voltage applications due to device voltage ratings and switching losses. The voltage rating of each switch must be at least V_{dc}/2, and all switches must operate at high switching frequency to maintain capacitor voltage balance and obtain output voltage with low harmonic distortion. These constraints make the conventional flying capacitor converter less suitable for high-voltage applications such as HVDC systems.

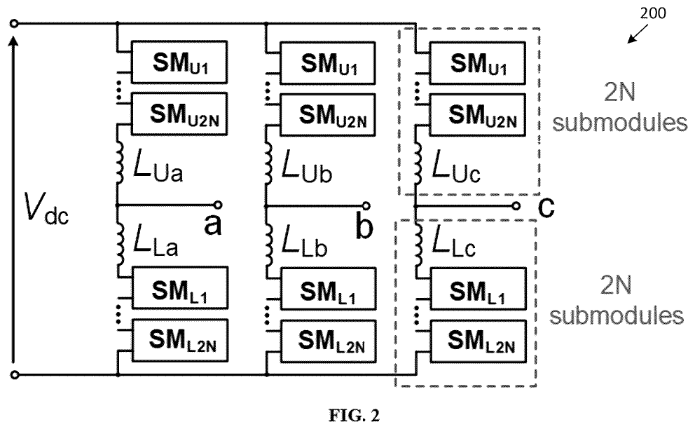

FIG. 2 illustrates a three-phase circuit diagram of a conventional modular multilevel converter (MMC) 200. The conventional MMC includes three phases (designated as phases a, b, and c), with each phase comprising an upper arm and a lower arm. Each arm contains 2N series-connected submodules, where N represents half of the total number of submodules per arm.

In the conventional MMC topology 200, the upper arms include submodules SM_{U1} through SM_{U2N}, while the lower arms include submodules SM_{L1} through SM_{L2N}. Each arm also incorporates an arm inductor (L_{Ua}, L_{Ub}, L_{Uc} for upper arms and L_{La}, L_{Lb}, L_{Lc} for lower arms). These arm inductors serve multiple functions, including limiting fault currents, facilitating current control, and suppressing circulating currents between phases.

A significant characteristic of the conventional MMC is that each arm must be capable of blocking the full DC-link voltage V_{dc}. This requirement necessitates a large number of series-connected submodules (2N) in each arm to achieve proper voltage sharing and desired output voltage resolution. The total number of submodules and their associated capacitors contributes significantly to the converter's cost, weight, and volume.

The conventional MMC topology 200, while providing excellent modularity and scalability, faces challenges in terms of component count and associated costs. The MMFC topology addresses these limitations by combining the benefits of both MMC and flying capacitor technologies, as will be further detailed in the description of subsequent figures.

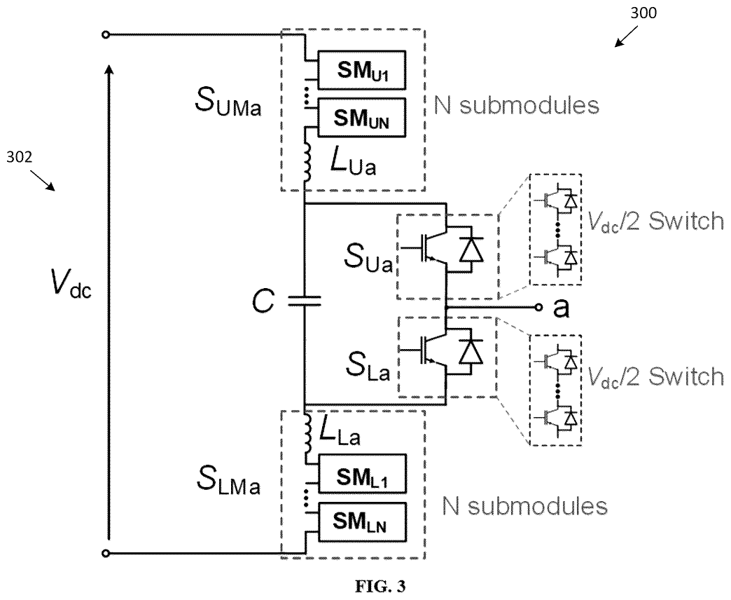

FIG. 3 illustrates a single-phase circuit diagram of an exemplary modular multilevel flying capacitor (MMFC) converter 300. The MMFC converter includes a DC side 302 having positive and negative terminals with a DC voltage V_{dc}, and an output terminal ‘a’ for connecting to an AC system (not shown). The converter 300 comprises an upper MMC arm (S_{UMa}) and a lower MMC arm (S_{LMa}), each containing N submodules (SM_{U1}-SM_{UN} and SM_{L1}-SM_{LN} respectively), two high-voltage switches (S_{Ua} and S_{La}), and a flying capacitor C.

The upper MMC arm S_{UMa} includes N series-connected submodules designated as SM_{U1} through SM_{UN}, and an arm inductor L_{Ua}. Similarly, the lower MMC arm S_{LMa} includes N series-connected submodules designated as SM_{L1} through SM_{LN}, and an arm inductor L_{La}. The arm inductors L_{Ua} and L_{La} help limit fault currents and facilitate current control during normal operation.

A feature of the MMFC topology is the placement of high-voltage switches S_{Ua} and S_{La}, which are positioned between the MMC arms and the AC output terminal ‘a’. Each high-voltage switch is designed to sustain half of the full DC voltage (V_{dc}/2). As shown in the detailed view, these switches can be implemented using series-connected switching devices, such as IGBTs with anti-parallel diodes, to achieve the required voltage rating.

The flying capacitor C is connected between the junction points of the high-voltage switches S_{Ua} and S_{La}. This capacitor serves two non-limiting functions: voltage balancing between the upper and lower arms, and voltage clamping for the series-connected switches. The maximum voltage across the flying capacitor C is maintained at approximately half of the full DC voltage (V_{dc}/2).

In operation, each submodule within the MMC arms can be individually controlled to generate the desired output voltage waveform. The high-voltage switches S_{Ua} and S_{La} operate at fundamental frequency, which significantly reduces switching losses compared to conventional MMC topologies. This arrangement allows the MMC arms to handle only half of the full DC voltage, thereby reducing the required number of submodules and associated components.

The modular structure of the MMFC converter 300 enables scalability to higher voltage levels by adding more submodules in series within each arm. The topology is compatible with various types of submodules, including but not limited to half-bridge, full-bridge, T-type, and full-bridge T-type configurations, which will be described in detail in subsequent figures.

Thus, limitations of the conventional flying capacitor converter of FIG. 1 are addressed by the MMFC topology shown in FIG. 3, which combines the benefits of flying capacitor technology with modular multilevel conversion. This hybrid approach enables higher voltage operation while maintaining the voltage-balancing advantages of flying capacitor structures.

Further, when compared to the MMFC topology of FIG. 3, the conventional MMC of FIG. 2 requires twice the number of submodules per arm to achieve the same DC voltage rating. This is because in the conventional MMC, each arm must handle the full DC voltage V_{dc}, whereas in the MMFC topology, the MMC arms only need to sustain half of the DC voltage (V_{dc}/2) due to the introduction of the flying capacitor and high-voltage switches.

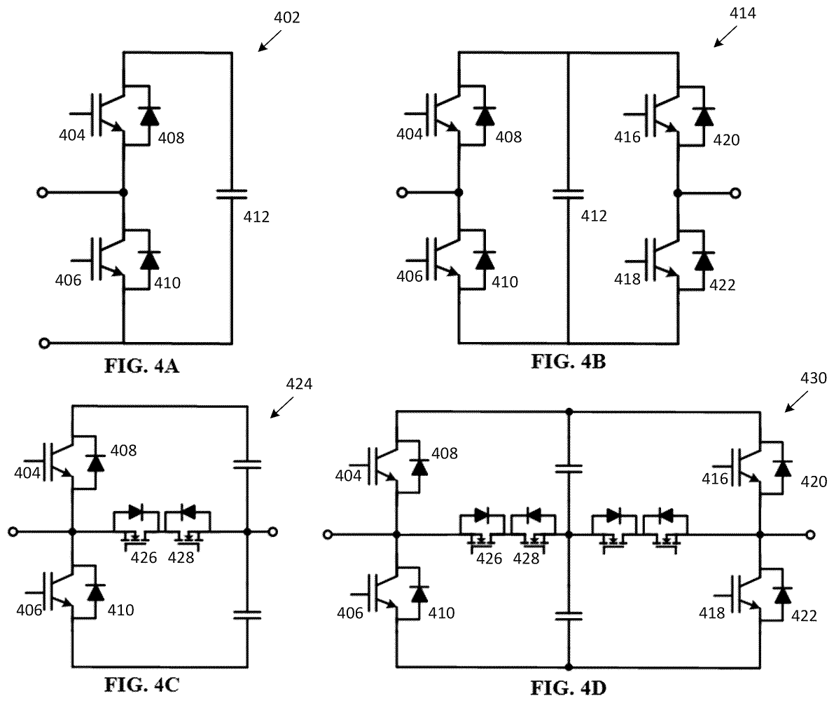

FIGS. 4A-4D illustrate exemplary circuit configurations for submodules that can be employed within the MMFC topology of FIG. 3. These configurations demonstrate the flexibility of the MMFC architecture in accommodating various submodule topologies to meet different application requirements.

FIG. 4A shows a half-bridge submodule configuration 402 comprising two IGBTs 404, 406 with anti-parallel diodes 408, 410 and a capacitor 412 connected across the DC terminals. This represents the simplest submodule topology and is particularly advantageous in applications where cost and complexity need to be minimized. The half-bridge configuration allows for two voltage states: zero voltage or the capacitor voltage.

FIG. 4B illustrates a full-bridge submodule configuration 414, which includes four IGBTs 404, 406, 416, 418 with anti-parallel diodes 408, 410, 420, 422 arranged in an H-bridge configuration with a capacitor 412. This topology offers enhanced flexibility compared to the half-bridge configuration, as it can generate both positive and negative voltage levels and provides DC fault blocking capability. The full-bridge arrangement enables three voltage states: positive capacitor voltage, negative capacitor voltage, or zero voltage.

FIG. 4C depicts a T-type converter submodule 424 that combines IGBTs with SiC MOSFETs. This hybrid configuration includes two IGBTs 404, 406 with anti-parallel diodes 408, 410 in a half-bridge arrangement, supplemented by a bidirectional switch implemented using SiC MOSFETs 426, 428 connected to the midpoint. The T-type structure offers improved efficiency at medium voltage levels while maintaining moderate component count.

FIG. 4D shows a full-bridge T-type converter submodule 430, which extends the concept of FIG. 4C to a full-bridge configuration. This topology incorporates four IGBTs 404, 406, 416, 418 with anti-parallel diodes 408, 410, 420, 422 in an H-bridge arrangement, with two bidirectional switches implemented using SiC MOSFETs. This configuration provides the most flexible voltage synthesis capabilities and the highest number of voltage levels, though at the cost of increased component count.

Each submodule topology offers distinct advantages in terms of cost, efficiency, control flexibility, and fault handling capability. The choice of submodule configuration within the MMFC converter can be optimized based on specific application requirements, such as voltage rating, switching frequency, efficiency targets, and fault tolerant capabilities.

The integration of these submodule configurations within the MMFC topology of FIG. 3 is particularly advantageous as the reduced voltage stress on each arm (V_{dc}/2) allows for more efficient utilization of the switching devices and potentially lower voltage-rated components compared to conventional MMC implementations.

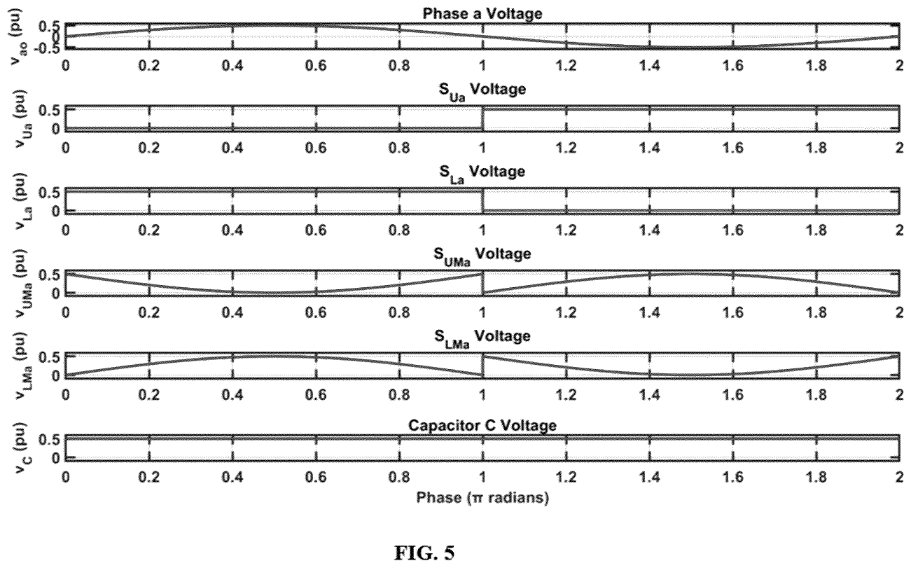

FIG. 5 illustrates key voltage waveforms that demonstrate the working principle of the MMFC converter over one fundamental cycle (2π radians). The waveforms are shown in per-unit (pu) values to illustrate the relative voltage relationships between different components of the converter.

The topmost waveform shows the Phase a Voltage, which represents the desired AC output voltage at terminal ‘a’ of the converter. This sinusoidal waveform is synthesized through the coordinated operation of the high-voltage switches (S_{Ua} and S_{La}) and the MMC arms (S_{UMa} and S_{LMa}).

The second and third waveforms show the S_{Ua} Voltage and S_{La} Voltage respectively, representing the voltage across the high-voltage switches. These switches operate at fundamental frequency, with each switch conducting for approximately half of the fundamental period. The voltage across each switch is maintained at approximately 0.5 pu (corresponding to V_{dc}/2) during their blocking state, demonstrating the voltage-sharing capability of the topology.

The fourth and fifth waveforms illustrate the S_{UMa} Voltage and S_{LMa} Voltage, representing the voltages synthesized by the upper and lower MMC arms respectively. These voltages are generated through the selective switching of submodules within each arm. Notably, the maximum voltage that each MMC arm must generate is limited to 0.5 pu, which enables the use of fewer submodules compared to conventional MMC topologies.

The bottom waveform shows the Capacitor C Voltage, representing the voltage across the flying capacitor. This voltage naturally oscillates around 0.5 pu, demonstrating the self-balancing nature of the topology. The flying capacitor serves as a voltage-clamping element for the high-voltage switches while facilitating the voltage distribution between the upper and lower portions of the converter.

The coordinated operation of these components enables the MMFC to synthesize the desired AC output voltage while maintaining balanced voltage distribution across all switching devices and capacitors. The fundamental frequency switching of S_{Ua} and S_{La} significantly reduces switching losses compared to conventional topologies where all switches operate at higher frequencies.

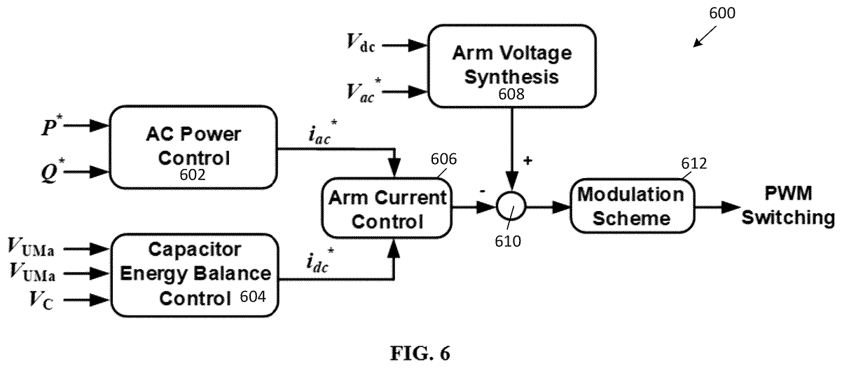

FIG. 6 illustrates a control block diagram for implementing the MMC arm control architecture 600 in the MMFC converter. The control architecture 600 comprises multiple functional blocks that work together to maintain stable operation and achieve desired power flow control while ensuring voltage balance across all components.

An AC Power Control block 602 receives active power reference (P*) and reactive power reference (Q*) commands and generates appropriate current references for the system. This block 602 is responsible for managing the overall power exchange between the AC and DC sides of the converter.

A Capacitor Energy Balance Control block 604 monitors the voltages of the upper and lower arm capacitors (V_{UMa} and V_{LMa}) as well as the flying capacitor voltage (V_{C}). This block 604 generates compensating current components to maintain balanced energy distribution among all capacitors in the system, which provides for stable operation of the converter.

An Arm Voltage Synthesis block 608 receives the DC voltage (V_{dc}) and its reference (V_{ac}*) as inputs and determines the required arm voltage references. These references set the desired AC output voltage.

The Arm Current Control block 606 processes the current references generated by the AC Power Control block 602 and the Capacitor Energy Balance Control block 604 to produce voltage correction terms. These correction terms compensate for any deviations from the desired current flow in the converter arms.

The control diagram includes a summation node 610 that combines the arm voltage references with the current controller outputs. The resulting signals are fed into a Modulation Scheme block 612, which generates the final pulse width modulated (PWM) switching signals for all semiconductor devices in the converter.

the Modulation Scheme block 612 implements appropriate switching patterns for the submodule switches within each MMC arm. This block sets proper voltage level generation while minimizing switching losses and maintaining capacitor voltage balance.

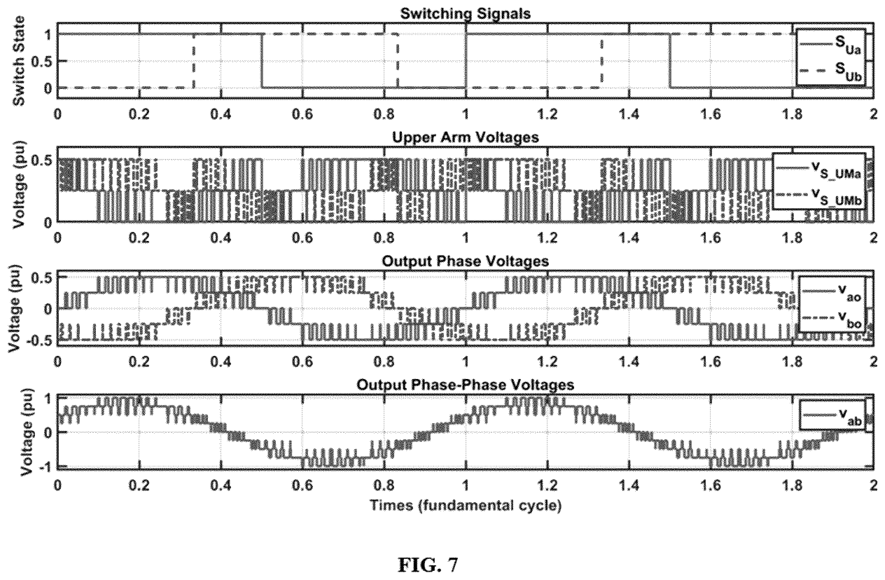

FIG. 7 illustrates the key control signals and voltage waveforms during operation of the MMFC converter over two complete fundamental cycles. The figure is organized in four parts to show the relationship between control signals and the resulting voltage outputs.

The top waveform shows the gate control signals for the high-voltage switches S_{Ua} and S_{Ub}. These switches operate at fundamental frequency with 120-degree phase shift. Each switch conducts for approximately half of the fundamental period, with appropriate dead time intervals between transitions to prevent shoot-through conditions.

The middle waveform displays the arm voltages V_S_{UMa} and V_S_{UMb} generated by the MMC arms. These multilevel voltage waveforms are produced through the selective activation of submodules within each arm. The voltage levels are stepped between 0, V_{dc}/4 and V_{dc}/2, demonstrating the reduced voltage stress on each arm compared to conventional MMC topologies.

The third waveform shows the resulting phase voltages Vₐₒ and V_{bo} generated by the MMFC converter phase a and phase b. This waveform spans from −V_{dc}/2 to +V_{dc}/2 and exhibits multiple voltage levels, achieved through the combined operation of the high-voltage switches and MMC arms.

The bottom waveform shows the resulting line-to-neutral voltage (V_{ab}) synthesized by the converter. This waveform spans from −V_{dc} to +V_{dc} and exhibits multiple voltage levels, achieved through the combined operation of the high-voltage switches and MMC arms. The multilevel nature of the output voltage helps reduce harmonic content and filtering requirements.

The stepped nature of the voltage waveforms demonstrates the modular operation principle, where individual submodules are activated or bypassed to create the desired voltage levels. The synchronization between the fundamental-frequency switching of S_{Ua} and S_{Ub} with the higher-frequency switching of the MMC submodules enables efficient voltage synthesis while maintaining low switching losses in the high-voltage switches.

The precise timing of the control signals and the resulting voltage waveforms is critical for achieving proper power flow control and maintaining balanced operation of the converter. The relationship between these waveforms illustrates how the MMFC topology successfully combines the benefits of fundamental-frequency switching in the high-voltage switches with the flexibility of multilevel voltage synthesis in the MMC arms.

### DETAILED WORKING PRINCIPLE

The MMFC converter operates according to the following fundamental principles to achieve efficient power conversion and voltage synthesis:

The AC output voltage synthesis is accomplished through coordinated control of the high-voltage switches and MMC arm voltages, as follows:
(a) during intervals when the upper switch S_{Ua} is conducting, the output voltage is determined by the difference between V_{dc}/2 and the upper MMC arm voltage;
(b) during intervals when the lower switch S_{La} is conducting, the output voltage is determined by the sum of −V_{dc}/2 and the lower MMC arm voltage; and
(c) the transitions between these states are managed to maintain continuous power flow and minimize voltage distortion.

The high-voltage switches S_{Ua} and S_{La} operate exclusively at the fundamental frequency of the desired AC output voltage. In multi-phase implementations, the switching patterns maintain precise phase relationships as follows:
(a) the switches operate in strict complementary mode within each phase leg;
(b) a phase displacement of 120 electrical degrees is maintained between successive phases in three-phase configurations;
(c) dead-time intervals are implemented during switching transitions to prevent shoot-through conditions.

The control and modulation of MMC arms is implemented through established modulation schemes, including, but not limited to:
(a) staircase modulation for high submodule count applications;
(b) phase-shifted carrier-based modulation for enhanced harmonic performance;
(c) level-shifted carrier-based modulation for optimized voltage balancing; and
(d) conventional sorting algorithms for submodule energy balancing.

The submodule switching operation provides multiple operating modes to optimize system performance:
(a) fundamental frequency switching mode, wherein:
   i. submodules generate staircase waveforms;
   ii. this mode is particularly suitable for configurations with high submodule counts.
(b) pulse width modulation mode, wherein:
   i. submodules operate at selected switching frequencies;
   ii. this mode is advantageous for configurations with limited submodule counts; and
   iii. enhanced output voltage quality is achieved through sinusoidal PWM techniques.

This coordinated operation of high-voltage switches and MMC arms enables the MMFC topology to achieve superior performance characteristics while maintaining the benefits of both flying capacitor and modular multilevel converter technologies.

### DETAILED CHARACTERISTICS AND ADVANTAGES

The MMFC topology achieves equivalent functionality to conventional MMC while providing substantial improvements in key performance metrics. The distinguishing characteristics of the MMFC topology are detailed below.

A primary characteristic of the MMFC topology is the reduction in required submodule count, as follows:
(a) the voltage stress on MMC arms is limited to half of the full DC voltage (V_{dc}/2);
(b) this voltage stress reduction enables:
   i. a 50% reduction in the number of required submodules compared to conventional MMC;
   ii. more efficient utilization of semiconductor devices.

The MMFC topology achieves enhanced switching efficiency through:
(a) fundamental frequency operation of high-voltage switches S_{Ua} and S_{La}, wherein
   i. switching losses are minimized compared to high-frequency operation;
   ii. thermal stress on switching devices is reduced.

The installation power capacity of semiconductor devices is optimized through:
(a) the reduced number of MMC submodules required;
(b) the efficient implementation of high-voltage switches, utilizing either:
   i. single high-voltage rated devices; or
   ii. series-connected lower-voltage rated devices; and
(c) optimized voltage and current stress distribution among components.

The MMFC topology achieves significant reduction in energy storage requirements through:
(a) reduced total capacitance requirements, enabled by:
   i. fewer submodule capacitors due to reduced submodule count;
   ii. optimized current stress distribution in the flying capacitor; and
   iii. efficient voltage balancing mechanisms;
(b) strategic placement of the flying capacitor to:
   i. provide voltage clamping for high-voltage switches;
   ii. facilitate voltage balancing between upper and lower arms; and
   iii. minimize required capacitance value.

These characteristics enable the MMFC topology to maintain full MMC functionality while providing:
(a) reduced system cost through fewer components;
(b) smaller physical footprint;
(c) lower overall system weight;
(d) improved efficiency through reduced losses; and
(e) simplified control requirements.

### INDUSTRY APPLICATIONS

The MMFC topology is advantageously applicable across numerous industry sectors where conventional MMC technology is currently employed, while providing substantial lifecycle cost reductions. The following detailed applications are exemplary and not limiting.

In HVDC power transmission applications, the MMFC topology enables:
(a) long-distance power transmission with:
   i. significantly reduced station costs;
   ii. enhanced power flow control capabilities;
(b) more economical implementation of voltage source converter (VSC) HVDC systems.

For asynchronous grid interconnection applications, the MMFC provides:
(a) cost-effective coupling between:
   i. asynchronous AC grids of different frequencies;
   ii. AC and DC grid systems;
In power distribution applications, the MMFC topology enables cost-effective implementation of:
(a) Static Synchronous Compensators (STATCOM);
(b) Unified Power Flow Controllers (UPFC);
(c) Active Power Filters (APF); and
(d) other power quality improvement devices.

For renewable energy integration, the MMFC topology facilitates:
(a) optimized grid connection of:
   i. utility-scale solar installations;
   ii. wind power plants;
   iii. other renewable energy sources;
(b) reduced lifecycle costs of power conversion equipment.

In motor drive applications, the MMFC topology provides:
(a) precise control of high-power motors with:
   i. reduced converter footprint;
   ii. lower system weight;
   iii. improved efficiency;
(b) cost-effective implementation in industrial drive systems.

For energy storage integration applications, the MMFC enables:
(a) efficient connection of large-scale energy storage systems for:
   i. grid balancing operations;
   ii. peak load management;
   iii. frequency regulation;
(b) integration of distributed energy storage systems including:
   i. photovoltaic systems with battery storage;
   ii. community-scale energy storage;
   iii. industrial microgrids.

In electric vehicle applications, the MMFC topology supports:
(a) implementation of high-power charging infrastructure with:
   i. reduced installation costs;
   ii. smaller physical footprint;
   iii. improved efficiency;
(b) bidirectional power flow capabilities for:
   i. vehicle-to-grid (V2G) applications;
   ii. grid support services.

The versatility of the MMFC topology enables its adoption across these applications while maintaining reduced lifecycle costs compared to conventional MMC implementations.

The construction and arrangement of the systems and methods as shown in the various implementations are illustrative only. Although only a few implementations have been described in detail in this disclosure, many modifications are possible (e.g., variations in sizes, dimensions, structures, shapes, and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

What we claim is:

1. A modular multilevel flying capacitor (MMFC) converter comprising:
a DC side having positive and negative terminals with a DC voltage; an upper modular multilevel converter (MMC) arm and a lower MMC arm, each arm comprising N series-connected submodules;
a flying capacitor; and
two high-voltage switches positioned between the MMC arms and an AC output terminal, wherein the flying capacitor is connected between junction points of the high-voltage switches, wherein each high-voltage switch is configured to sustain half of the full DC voltage, and wherein the MMC arms are configured to handle half of the full DC voltage.

2. The MMFC converter of claim 1, wherein the upper MMC arm includes N series-connected submodules and an upper arm inductor, wherein the lower MMC arm includes N series-connected submodules and a lower arm inductor, and wherein the flying capacitor maintains a voltage of approximately half of the full direct current (DC) voltage.

3. The MMFC converter of claim 1, wherein the high-voltage switches comprises an upper switch (S_{Ua}) and a lower switch (S_{La}), wherein the switches operate in complementary fashion at fundamental frequency of the alternating current (AC) output voltage and wherein the switches may be implemented as single switches or series-connected switches.

4. The MMFC converter of claim 1, wherein the submodules comprise at least one of: half-bridge submodules; full-bridge submodules; T-type converter submodules; or full-bridge T-type converter submodules.

5. The MMFC converter of claim 1, wherein each submodule comprises: semiconductor switches implemented with any type of fully controllable switches selected from the group consisting of IGBTs, IGCTs, MOSFETs, and HEMTs, and wherein the semiconductor switches are made of any types of semiconductor materials selected from the group consisting of Si, SiC, GaN, and ultrawide bandgap semiconductors.

6. A method of operating a modular multilevel flying capacitor (MMFC) converter, comprising:
synthesizing alternating current (AC) output voltage by coordinating switching states between high-voltage switches operating at fundamental frequency and modular multilevel converter (MMC) arms operating using selective submodule insertion; and
implementing submodule voltage balancing control.

7. The method of claim 6, wherein synthesizing AC output voltage further comprises:
generating output voltage as difference between half direct current (DC) voltage and upper MMC arm voltage when upper switch is conducting; and
generating output voltage as sum of negative half DC voltage and lower MMC arm voltage when lower switch is conducting.

8. The method of claim 6, wherein the MMC arms are controlled using at least one of:
staircase modulation; phase-shifted carrier-based modulation; level-shifted carrier-based modulation; or conventional submodule sorting methods.

9. The method of claim 6, further comprising operating submodules in fundamental frequency mode generating staircase waveforms when number of submodules is high or pulse width modulation mode at selected switching frequency when number of submodules is limited.

10. The method of claim 6, wherein an AC power control block receives active power reference (P*) and reactive power reference (Q*) commands and generates current references for the converter.

11. The method of claim 10, wherein a Capacitor Energy Balance Control block monitors voltages of the MMC and a flying capacitor voltage (V_{C}) to generate a compensating current components to maintain balanced energy distribution among all capacitors in the converter.

12. The method of claim 11, wherein an Arm Current Control block processes the current references generated by the AC Power Control block and the Capacitor Energy Balance Control block to produce voltage correction terms.

13. The method of claim 12, wherein an Arm Voltage Synthesis block receives a DC voltage (V_{dc}) and an associated reference (V_{dc}*) and determines arm voltage references.

14. The method of claim 13, wherein a modulation scheme block which receives summed outputs from the Arm Control Current block and the Arm Voltage Synthesis block to determine appropriate switching patterns for submodule switches within each MMC arm.

15. A power conversion system comprising the MMFC converter of claim 1, wherein the system is configured for at least one of: High Voltage DC (HVDC) power transmission;
asynchronous grid connection; power distribution; renewable energy integration; motor drives;
energy storage integration; or electric vehicle charging infrastructure.
